(19) United States
(12) Patent Application Publication
(10) Pub. No.: US 2023/0254300 A1
(43) Pub. Date: Aug. 10, 2023

(54) AUTHENTICATION OF AVATARS FOR IMMERSIVE REALITY APPLICATIONS

(71) Applicant: Meta Platforms Technologies, LLC, Menlo Park, CA (US)

(72) Inventors: Barry David Silverstein, Kirkland, WA (US); Tomas Simon Kreuz, Pittsburgh, PA (US); Jason Saragih, Pittsburgh, PA (US)

(21) Appl. No.: 17/665,237

(22) Filed: Feb. 4, 2022

(51) Int. Cl. H04L 9/40; H04L 9/32

(52) U.S. Cl. CPC H04L 63/0823; H04L 9/3263; H04L 9/321; H04L 2209/38

(57) ABSTRACT

A method for authenticating an avatar for use in a virtual reality/augmented reality (VR/AR) application is provided. The method includes receiving, from a client device, a request for authenticating an identity of a user of an immersive reality application running in the client device, wherein the user is associated with a subject-based avatar in the immersive reality application. The computer-implemented method also includes verifying, in a server, a public key provided by the client device against a private key stored in the server, the private key associated with the subject-based avatar, providing, to the client device, a certificate of validity of the identity of the user when the public key matches the private key, and storing an encrypted version of the certificate of validity in a memory. A memory storing instructions and a system to perform the above method are also provided.

### BACKGROUND

### Field

The present disclosure is related to use of avatars for individuals in immersive reality applications such as augmented reality or virtual reality (AR/VR) applications. More specifically, the present disclosure is related to handling authentication credentials, data privacy, security, and ownership of avatars and related applications for individuals in a computer network providing AR/VR applications.

### Related Art

Avatars are a convenient tool for computer applications involving virtual reality, such as website portals having virtual assistants, virtual chat rooms, exercise rooms and groups, games, social networks, and the like. As the realm of virtual reality applications expands beyond entertainment and into the job market, finances, business, and other transactions, ownership of avatar identities will become a forefront issue for network service providers, employers, financial institutions, and the like. While blockchain networks have seen a surge in applications to different aspects of contractual transactions, the avatar concept and its cross-device, cross-application presence potential presents a challenge to traditional encryption handling techniques.

### SUMMARY

In a first embodiment, a computer-implemented method includes receiving, from a client device, a request for authenticating an identity of a user of an immersive reality application running in the client device, wherein the user is associated with a subject-based avatar in the immersive reality application. The computer-implemented method also includes verifying, in a server, a public key provided by the client device against a private key stored in the server, the private key associated with the subject-based avatar, providing, to the client device, a certificate of validity of the identity of the user when the public key matches the private key, and storing an encrypted version of the certificate of validity in a memory.

In a second embodiment, a computer-implemented method includes receiving, in a server, an authentication credential from a first user via a client device, the authentication credential encrypted with a public key provided by the client device. The computer-implemented method also includes validating the authentication credential with a private key associated with the public key, associating a model for a three-dimensional representation of a subject with a metadata for an identity of the first user, and providing, to an application running in the client device, the model for the three-dimensional representation of the subject. The computer-implemented method also includes retrieving, from the client device, a streaming of the application including a three-dimensional representation of the first user, and updating the model of the three-dimensional representation of the subject using the streaming of the application.

In a third embodiment, a system includes a memory storing instructions, and a processor configured to execute the instructions to cause the system to perform operations. The operations include to receive, in a server, an authentication credential from a first user via a client device, the authentication credential encrypted with a public key provided by the client device, to validate the authentication credential with a private key associated with the public key, and to associate a model for a three-dimensional representation of a subject with a metadata for an identity of the first user. The operations also include to provide, to an application running in the client device, the model for the three-dimensional representation of the subject, to retrieve, from the client device, a streaming of the application including a three-dimensional representation of the first user, and to update the model of the three-dimensional representation of the subject using the streaming of the application.

In a fourth embodiment, a non-transitory, computer-readable medium stores instructions which, when executed by a processor, cause a computer to perform a method. The method includes receiving, in a server, an authentication credential from a first user via a client device, the authentication credential encrypted with a public key provided by the client device, and validating the authentication credential with a private key associated with the public key. The method also includes associating a model for a three-dimensional representation of a subject with a metadata for an identity of the first user, providing, to an application running in the client device, the model for the three-dimensional representation of the subject, and retrieving, from the client device, a streaming of the application including a three-dimensional representation of the first user. The method also includes updating the model of the three-dimensional representation of the subject using the streaming of the application.

In yet other embodiments, a system includes a first means for storing instructions, and a second means for executing the instructions to cause the system to perform a method. The method includes receiving, in a server, an authentication credential from a first user via a client device, the authentication credential encrypted with a public key provided by the client device, and validating the authentication credential with a private key associated with the public key. The method also includes associating a model for a three-dimensional representation of a subject with a metadata for an identity of the first user, providing, to an application running in the client device, the model for the three-dimensional representation of the subject, and retrieving, from the client device, a streaming of the application including a three-dimensional representation of the first user. The method also includes updating the model of the three-dimensional representation of the subject using the streaming of the application.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture suitable for providing a real-time avatar of a subject for a network application, according to some embodiments.

FIG. 2 is a block diagram illustrating an example server and client from the architecture of FIG. 1, according to certain aspects of the disclosure.

FIG. 3 illustrates an identity issuing organization providing an authentication certificate for a subject avatar based on an individual, according to some embodiments.

FIG. 4 illustrates a server providing a model for a subject avatar based on an individual, and a server hosting a VR application immersing the subject avatar in a virtual reality environment, the application being run in a client device, according to some embodiments.

FIG. 5 illustrates a social scenario with subject-based avatars interacting in a virtual environment by a virtual reality application, according to some embodiments.

FIG. 6 illustrates a contractual scenario with subject-based avatars interacting in a virtual environment by a virtual reality application, according to some embodiments.

FIG. 7 is a flow chart illustrating steps in a method for certifying a subject avatar for multiple network applications, according to some embodiments.

FIG. 8 is a flow chart illustrating steps in a method for authenticating a subject avatar for multiple network applications, according to some embodiments.

FIG. 9 is a flow chart illustrating steps in a method for authenticating a subject avatar for multiple network applications, according to some embodiments.

FIG. 10 is a block diagram illustrating an example computer system with which the client and server of FIGS. 1 through 4 and the method of FIGS. 7-9 can be implemented.

In the figures, elements and steps denoted by the same or similar reference numerals are associated with the same or similar elements and steps, unless indicated otherwise.

### DETAILED DESCRIPTION OF THE DRAWINGS

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

In AR/VR applications, avatars are becoming more sophisticated as models for three-dimensional rendition of subjects make strong progress in fidelity and speed. Accordingly, subject-based avatars can be “true” representations of individuals, raising the question about identity ownership, fair usage, and even profitability for VR/AR service providers. In many instances, realistic, subject-based avatars may be able to access financial data or perform critical transactions in a virtual environment, and it is desirable that proper control and ownership of these avatars be exercised by their users and controlled by the service providers.

Currently, identity validation procedures for real subjects use birth certificates and multiple forms of identification using photographs, holograms, and other codes printed into physical documents such as passports, driver licenses, and the like. These physical documents can be scanned by suitable devices and become formal ownership of identity. The emission of these documents is controlled by an authorized “identity issuing organization” such as governments, and other public entities. With the advent of modern bio-technologies such as DNA sequencing, iris pattern recognition, and fingerprint recognition, identification codes may also include biological data, perhaps established at birth. Accordingly, embodiments as disclosed herein include the processing and handling of the above identification techniques associated to a subject-based avatar in the context of a blockchain network.

In real life, when doing financial and other transactions involving identity verification, the traditional approach is to have notaries, witnesses, and government-issued documents like passports, birth certificates, and drivers licenses to control authenticity. Embodiments as disclosed herein provide a technical solution to, automatically and remotely, verify the identity and ownership of a subject-based avatar using a blockchain network without the need to reach a real person.

To resolve the above problem arising in the realm of computer networks and immersive reality applications, embodiments disclosed herein make use of blockchain networks for encoding authentication protocols. Accordingly, a subject-based avatar model may be publicly available as a collection of encrypted blocks that can be accessed by a VR/AR application only when the user accessing a client device has the proper authorization credentials (e.g., associated with the identity and/or ownership of the subject-based avatar). Accordingly, the subject-based avatar may be accessed via different client devices and different VR/AR applications as long as the user has the proper authentication keys in those devices.

In some embodiments, the blockchain ownership keys for a subject-based avatar model are transferred when the identity issuing organization verifies the identity of a user, or legitimate owner of the subject-based avatar. This verification by the identity issuing organization is publicly stored in the blockchain database and intrinsically associated with the subject-based avatar model across devices and VR/AR applications. The subject-based avatar is then the officially recognized avatar of the authorized individual. Accordingly, the subject-based avatar model becomes recognized as the authorized individual for any transactions in the VR/AR application. In this regard, the publicly available blockchain network becomes a trusted party where a third party may verify that the subject-based avatar truly represents an individual in question (e.g., a bank or financial organization, or a counterparty in a VR/AR chat room or game, and the like).

In some embodiments, the user of a client device may attach a hardware key code to the client device. The hardware key code may include a public key used by the blockchain network to authenticate the user when a VR/AR application in the client device requests access to the subject-based avatar.

In some embodiments, a solution to the above technical problem includes other digital authentication paradigms, such as steganography. Accordingly, relevant identifying information may be stored in the least significant bits of a data file associated with a subject-based avatar model stored in a VR/AR server. The identifying information may be hashed or compared with identifying information of a user in a client device attempting to access the VR/AR server via a VR/AR application.

### Example System Architecture

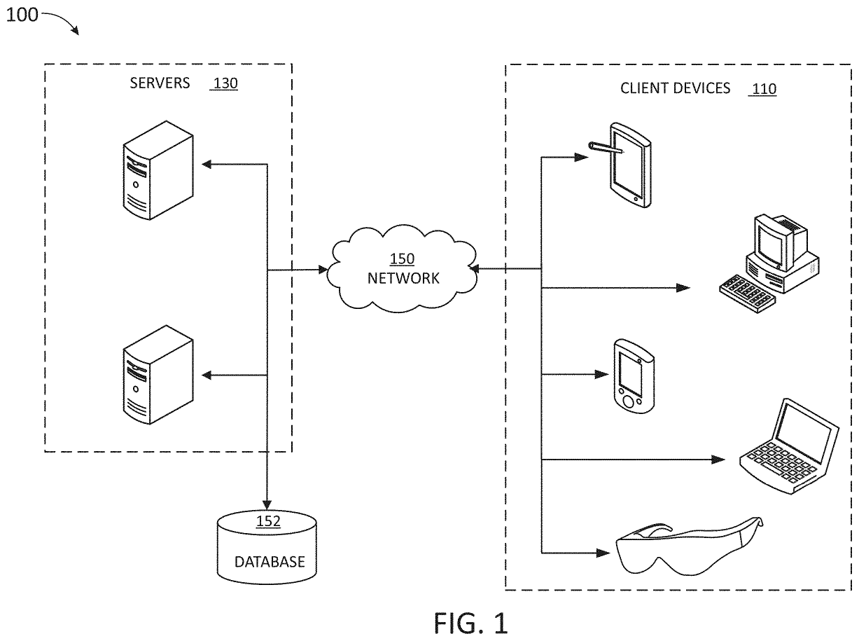

FIG. 1 illustrates an example architecture 100 suitable for providing a real-time avatar of a subject for a network application, according to some embodiments. Architecture 100 includes servers 130 communicatively coupled with client devices 110 and at least one database 152 over a network 150. One of the many servers 130 is configured to host a memory including instructions which, when executed by a processor, cause the server 130 to perform at least some of the steps in methods as disclosed herein. In some embodiments, the processor is configured to control a graphical user interface (GUI) in an application for the user of one of client devices 110 accessing an avatar model engine or a blockchain engine. The avatar model engine may be configured to train a machine learning model for solving a specific application. Accordingly, the processor may include a dashboard tool, configured to display components and graphic results to the user via the GUI. For purposes of load balancing, multiple servers 130 can host memories including instructions to one or more processors, and multiple servers 130 can host a history log and databases including multiple training archives used for the avatar model engine. Moreover, in some embodiments, multiple users of client devices 110 may access the same avatar model engine to run one or more machine learning models. In some embodiments, a single user with a single client device 110 may train multiple machine learning models running in parallel in one or more servers 130. Accordingly, client devices 110 may communicate with each other via network 150 and through access to one or more servers 130 and resources located therein.

Servers 130 may include any device having an appropriate processor, memory, and communications capability for hosting the avatar model engine or the blockchain engine, including multiple tools associated with it. The avatar model engine may be accessible by various clients 110 over network 150. Client devices 110 can be, for example, desktop computers, mobile computers, tablet computers (e.g., including e-book readers), mobile devices (e.g., a smartphone or PDA), or any other device having appropriate processor, memory, and communications capabilities for accessing the avatar model engine on one or more of servers 130. In some embodiments, client device 110 is a VR/AR headset, running a VR/AR application for the user. Further, in some embodiments, a client device 110 may include a mobile device (e.g., smartphone or tablet) communicatively coupled with the VR/AR headset, and hosting the VR/AR application to control the VR/AR headset. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

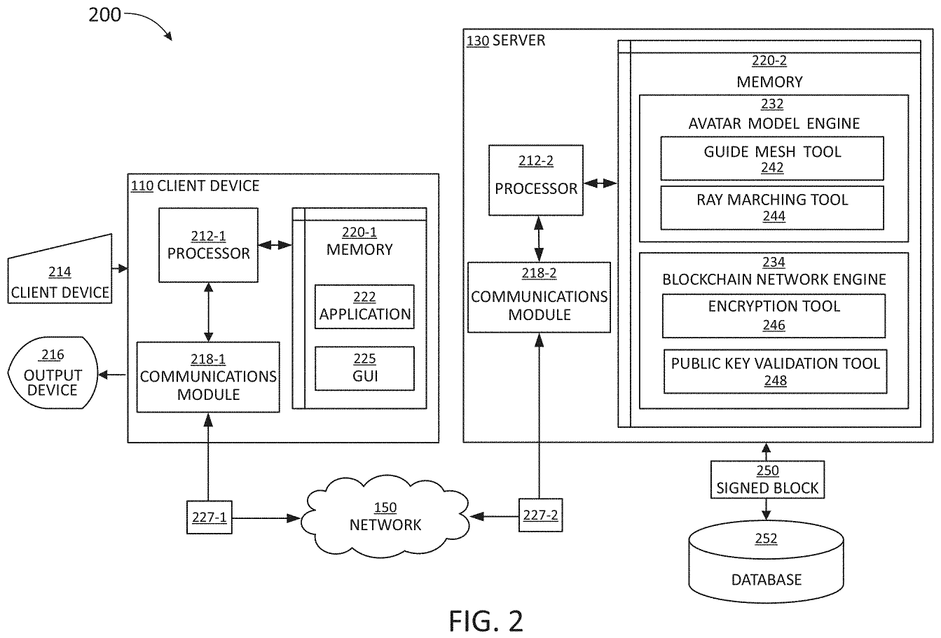

FIG. 2 is a block diagram 200 illustrating an example server 130 and client device 110 from architecture 100, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. A user may interact with client device 110 via an input device 214 and an output device 216. Input device 214 may include a mouse, a keyboard, a pointer, a touchscreen, a microphone, and the like. Output device 216 may be a screen display, a touchscreen, a speaker, and the like. Client device 110 may include a memory 220-1 and a processor 212-1. Memory 220-1 may include an application 222, configured to run in client device 110 and couple with input device 214 and output device 216. Application 222 may be downloaded by the user from server 130, and may be hosted by server 130. Application 222 may be a VR/AR application such that a user of client device 110 may participate in an immersive reality experience alone, or with other participants, using their respective individualized, subject avatars. A graphical user interface (GUI) 225 enables the user of client device 110 to provide commands to and adjust settings of, application 222. In that regard, client device 110 may be a VR/AR headset, communicatively coupled with a mobile device associated with the user of the VR/AR headset.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an avatar model engine 232. Avatar model engine 232 may share or provide features and resources to application 222, including multiple tools associated with managing authentication credentials for a subject avatar. The user may access avatar model engine 232 through application 222 installed in a memory 220-1 of client device 110. Accordingly, application 222 may be installed by server 130 and perform scripts and other routines provided by server 130 through any one of multiple tools. Execution of application 222 may be controlled by processor 212-1. Application 222 may be any VR/AR application, including revenue-based applications. For example, application 222 may be a physical therapy application, an exercise application (e.g., personal training or group training), an educational application, a gaming application, or a financial transaction application, or a social application including a celebrity, or any type of social application, e.g., dating and the like. In some embodiments, application 222 may include a medical or healthcare application, or a business communication application.

In that regard, avatar model engine 232 may be configured to create, store, update, and maintain a three-dimensional animation model of a subject, as disclosed herein. The three-dimensional animation model may include, in addition to encoders and decoders, tools such as a guide mesh tool 242 and a ray marching tool 244. In some embodiments, avatar model engine 232 may access one or more machine learning models stored in a training database 252. A database 252 includes training archives and other data files that may be used by avatar model engine 232 in the training of a machine learning model, according to the input of the user through application 222. Moreover, in some embodiments, at least one or more training archives or machine learning models may be stored in either one of memories 220, and the user may have access to them through application 222.

Guide mesh tool 242 determines facial expression parameters (z) based on input images, upon a classification scheme that is learned by training. In some embodiments, guide mesh tool 242 includes a head pose encoder to determine a rotation (e.g., a matrix, r) and a translation (e.g., a vector, t) of the head of a person in the input images. In some embodiments, avatar model engine 232 may also determine a camera viewpoint vector (v^{v}). Ray marching tool 244 performs a ray accumulation of color and opacity according to selected mathematical rules along a view vector to model view-dependent phenomena.

In some embodiments, memory 220-2 may include a blockchain network engine 234. Blockchain network engine 234 includes an encryption tool 246 and a public key validation tool 248. Public key validation tool 248 is configured to validate, authenticate, and verify access from different client devices 110 and servers 130 to database 152, which may be configured as a blockchain database. Accordingly, server 130 may verify and apply a signature to a data block before storing in database 152. In some embodiments, memories 220 may include low latency memories, such as RAM (dynamic-RAM—DRAM—, or static RAM—SRAM—) that can be accessed quickly from an external device via a plugin socket in communications modules 218.

Data packets 227-1 and 227-2 (hereinafter, collectively referred to as “data packets 227”) may include time-sensitive information (e.g., time stamps and other metadata) and data value updates (e.g., an updated avatar model, a new user gesture, a new illumination source model, and the like). In some embodiments, data packets 227 may include encryption data and passwords, such as public keys and private keys. Moreover, in some embodiments, data packets 227 may include data signed by an authorized client or server in the blockchain network and already stored in memories 220. In some embodiments, data packets 227 may include a “blob” with multiple passwords, each password associated with a time-sensitive value. When a data packet or data update is accessed by a block producer in the blockchain network, it is saved as a signed/verified block 250 in database 252. In some embodiments, signed block 250 may include other action results from other external client devices 110, including various signatures and mechanisms to make it cryptographically secure. Signed block 250 may then be sent from server 130 to other block producers or client devices where it could be re-run (using the decrypted data) by a blockchain application.

In some embodiments, a machine learning model as disclosed herein may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, database 252 may include a training archive to modify coefficients according to a desired outcome of the machine learning model. Accordingly, in some embodiments, avatar model engine 232 is configured to access database 252 to retrieve documents and archives as inputs for the machine learning model. In some embodiments, avatar model engine 232, the tools contained therein, and at least part of training database 252 may be hosted in a different server that is accessible by server 130.

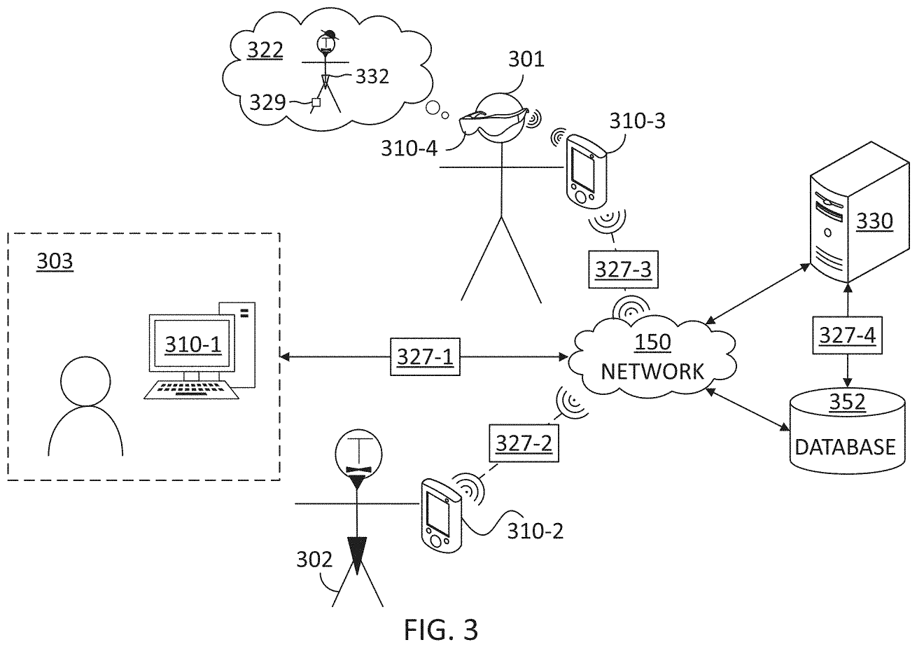

FIG. 3 illustrates an identity issuing organization 303 providing an authentication certificate 327-1 for a subject avatar 332 based on an individual 302, according to some embodiments. Individual 302 physically shows up at identity issuing organization 303, which then issues authentication certificate 327-1 via a desktop 310-1. Certificate 327-1 may be communicated via network 150 to a server 330, which stores an encrypted version 327-4 of the certificate in a database 352 (e.g., a blockchain database). Individual 302 may also receive an encrypted version 327-2 of the certificate and store it in a smart phone 310-2.

A user 301 of a VR/AR device 310-4 may want to authenticate subject avatar 332 when it appears in a VR/AR application 322 running in VR/AR device 310-4. To do this, user 301 requests a version 327-3 of the issued certificate 327-1 from server 330, via a smart phone 310-3 after the identity of the owner of subject avatar 332 (e.g., individual 302) has been verified. Hereinafter, any one of desktop 310-1, smart phones 310-2 and 320-3, and VR/AR device 310-4 will be collectively referred to as “client devices 310.” In some embodiments, individual 302 authenticates its identity by exchanging certificate 327-2 with user 301, via network 150 and client devices 310. As mentioned above, at least part of network 150 may include a blockchain network including server 330 and database 352.

In general, the events depicted may not be simultaneous. For example, issuance of certificate 327-1 by organization 303 may occur at an earlier time, or much earlier time, compared to issuance of certificate 327-3 to user 301 by server 330. Identity issuing organization 303 may be a government entity, a healthcare organization, or even a financial organization. In some embodiments, identity issuing organization 303 may be a private enterprise having technical control over subject-based avatars, such as a computer networking or social network enterprise. In yet some other embodiments, identity issuing organization 303 may be any one of a financial institution, a healthcare provider or a private enterprise, in conjunction with a government authority (e.g., the department of motor vehicles, or any other type of civil, public, or private organization) in charge of issuing documentation such as drivers licenses, birth certificates, passports, and the like. In that regard a physical credential (e.g., picture or biomarker, and the like) may be associated with an encrypted token accessible to authorized parties via a blockchain network.

More specifically, user 301 may be an external viewer of avatar 332 through VR/AR device 310-4, and may request validation to a key holder (e.g., individual 302 or some other third party) who then chooses to validate or not. In some embodiments, the request is made and sent to server 330, which relays the request to the owner (e.g., individual 302, or a third party) who allows validation. To prevent the request from user 301 going to a fake validation service (e.g., a malicious server proxying for a trusted server 330), or an illegitimate user 301 making the request, server 303 may request user 301 to present a validation credential for a personal account. In some embodiments, user 301 may be required to sign up for a trusted application service to prevent fake validations to make sure that the request for certificate 327-3 is legitimate. The trusted application service may be hosted by server 330, or a third party server communicatively coupled to server 330 and database 352.

In some embodiments, the owner of avatar 332 (e.g., individual 302, or a third party) may choose to provide an open validation option to any user 301, or not. For example, for an open validation, a tag 329 may be placed on avatar 332 to enable easy and trusted validation. Accordingly, the request for certificate 327-3 may be activated by user 301 simply by activating tag 329 (using input control accessories to VR/AR device 310-4).

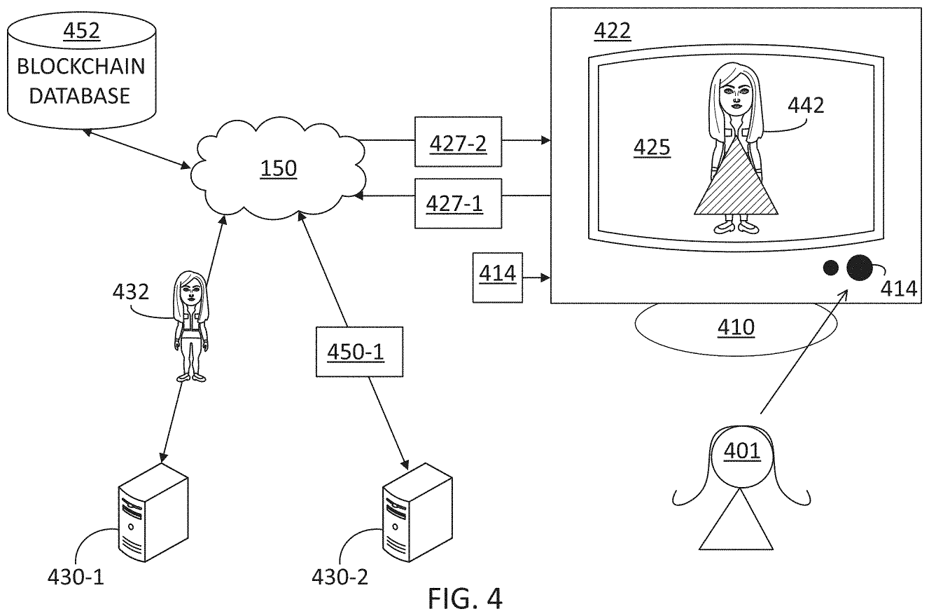

FIG. 4 illustrates a server 430-1 providing a model 432 for a subject avatar based on an individual, and a server 430-2 hosting a VR application 422 immersing the subject avatar in a virtual reality environment. Application 422 runs in a client device 410, according to some embodiments. Server 430-2 provides an encrypted block 450-1 with an authentication credential 427-1 provided by client device 410 to use and access avatar model 432. Authentication credential 427-1 ensures that a user 401 sitting/standing/performing in front of client device 410 is the legitimate owner of avatar model 432. In some embodiments, user 401 may be a trainer in a physical exercise server hosting an exercise VR/AR. In some embodiments, user 401 may be an actor or other celebrity in a social network VR/AR application, or even in a TV/streaming entertainment server hosting an advertisement or movie production VR/AR application.

In some embodiments, user 401 may couple a key device 414 including authentication credential 427-1 to client device 410. Key device 414 may include a hardware embedded encrypted code including an authentication credential. Accordingly, user 401 may carry key device 410 across multiple client devices, and use it to access the individualized avatar model 432 from any device, and any application.

Encrypted block 450-1 is received and authenticated by server 430-2 and avatar model 432 is provided to application 422 to display in a GUI 425 of client device 410.

Client device 410 receives a data packet 427-2 including avatar model 432 and a public key. Client device 410 recreates a three-dimensional representation 442 of user 401 by providing an input image or video from camera 414 of user 401 to avatar model 432.

In some embodiments, server 430-1 may store, in blockchain database 452, a stack of encrypted blocks including model 432 and each of the different VR/AR transactions where model 432 has been used. This blockchain may be used by server 430-1 to update model 432 with new video footage of user 401 provided by client device 410. In addition, the blockchain of model 432 may be used by server 430-1 to charge or credit an account associated with user 401, according to some monetization schemes and a contract. In fact, in some embodiments, a contract between server 430-1 and user 401 for the use and ownership of avatar model 432 in revenue-based VR/AR applications may also be stored in blockchain database 452. For example, in some embodiments, a fitness training application may log in fitness training sessions of a specific trainer, or a movie/streaming production application may store different scenes and time used by a specific actor during production.

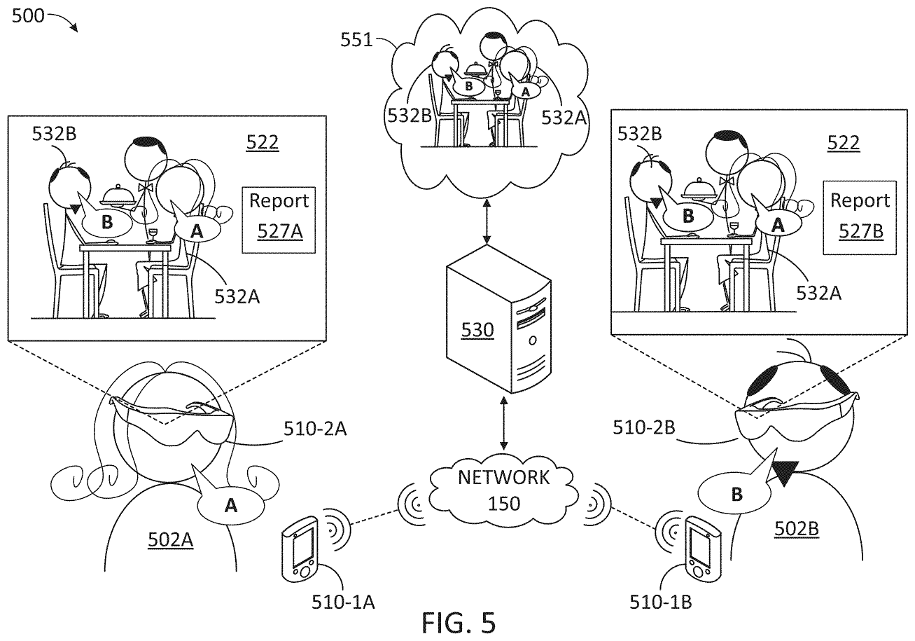

FIG. 5 illustrates a social scenario 500 with subject-based avatars 532A and 532B (hereinafter, collectively referred to as “subject-based avatars 532”) interacting in a virtual environment 551 by a virtual reality application 522, according to some embodiments. Network server 530, mobile devices 510-1A and 510-1B (hereinafter, collectively referred to as “mobile devices 510-1”), VR headsets 510-2A and 510-2B (hereinafter, collectively referred to as “headsets 510-2”), are as described heretofore (cf. client devices 110, 310, and 410 and servers 130, 330, and 430). Mobile devices 510-1 and headsets 510-2 will be referred to, collectively, as “client devices 510”). Subject-based avatar 532A (532B) is associated with a user 502A (502B), and the association may be verified via the authentication mechanisms and credentials described in this disclosure (cf. FIGS. 3-4). In that regard, network 150 may be a blockchain network including server 530. Users 502A and 502B may be collectively referred, hereinafter, as “users 502.”

Accordingly, virtual reality application 522 may include “report” flags 527A and 527B (hereinafter, collectively referred to as “report flags 527”) in the display for each of users 502. Report flags 527 may be activated by users 502 in case there is an inappropriate action or occurrence by the opposite party in virtual environment 551. For example, user 502A may report a “virtual groping” action by user 502B (or vice versa), harassment, abuse, and the like. Server 530 may tag the corresponding subject-based avatar 532 with the report made by the respective user. In some embodiments, the report may be added to a blockchain thread associated with the respective one of subject-based avatars 532, and server 530 may take certain measures (e.g., restriction, penalties, or exclusion) on the one or more users 502 linked to the subject-based avatar. In some embodiments, there may be legal/administrative consequences for one or both of users 502 based on the report.

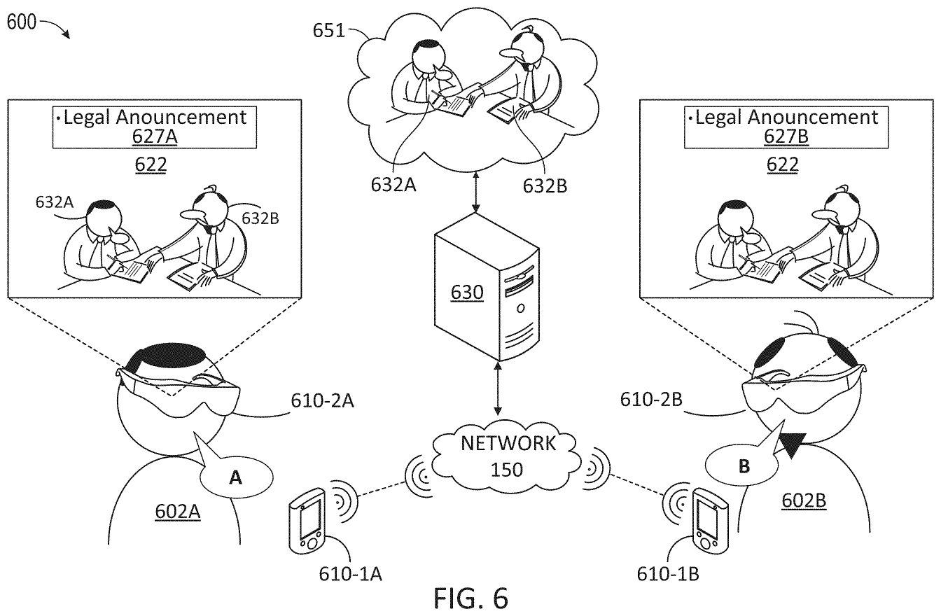

FIG. 6 illustrates a contractual scenario 600 with subject-based avatars 632A and 632B (hereinafter, collectively referred to as “subject-based avatars 632”) interacting in a virtual environment 651 by a virtual reality application 622, according to some embodiments. Network server 630, mobile devices 610-1A and 610-1B (hereinafter, collectively referred to as “mobile devices 610-1”), VR headsets 610-2A and 610-2B (hereinafter, collectively referred to as “headsets 610-2”), are as described heretofore (cf. client devices 110, 310, and 410 and servers 130, 330, and 430). Mobile devices 610-1 and headsets 610-2 will be referred to, collectively, as “client devices 610”). Subject-based avatar 632A (632B) is associated with a user 602A (602B), and the association may be verified via the authentication mechanisms and credentials described in this disclosure (cf. FIGS. 3-4). In that regard, network 150 may be a blockchain network including server 630. Users 602A and 602B may be collectively referred, hereinafter, as “users 602.”

Accordingly, virtual reality application 622 may include a “legal/administrative” flag 627A and 627B (hereinafter, collectively referred to as “flags 627”) in the display for each of users 602. Flags 627 may indicate that “the terms of the contract being signed by the parties is subject to the laws of [jurisdiction]” in virtual environment 651. Accordingly, flags 627 may prompt users 602 to accept the legal/administrative terms, in which case subject-based avatars 632 become legal entities protected by or under the obligations of, the specific jurisdiction.

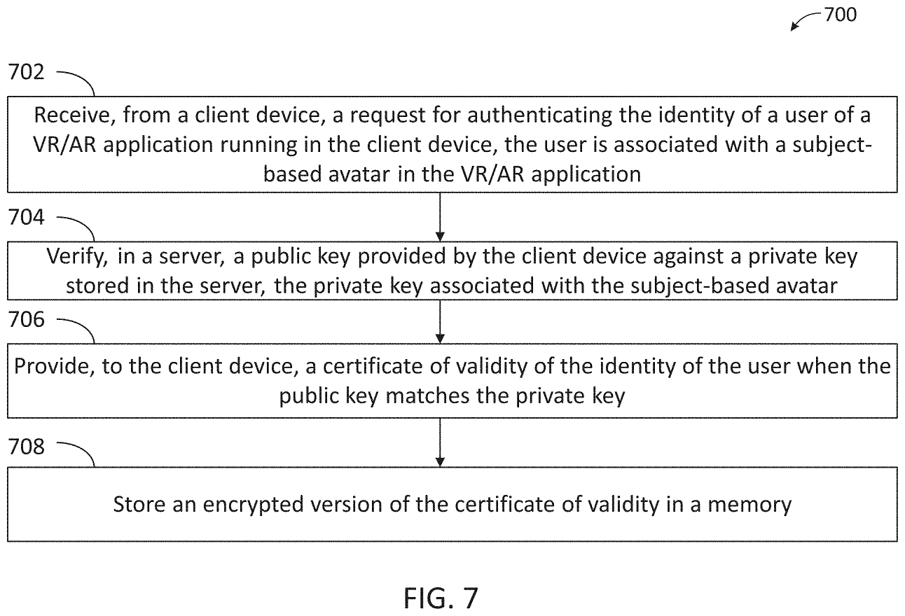

FIG. 7 is a flow chart illustrating steps in a method for certifying a subject avatar for multiple network applications, according to some embodiments. Method 700 may be performed by a system including client devices, servers, and at least one database communicatively coupled with each other via communications modules via a network, as disclosed herein (e.g., client devices 110, servers 130, databases 152, 252, 352, and 452, communications modules 218, and network 150). The servers and client devices may include processors configured to execute instructions stored in memories as disclosed herein (e.g., processors 212 and memories 220). In some embodiments, the instructions in a memory may include an avatar model engine configured to create and update a personalized avatar model engine, a blockchain network engine, and a graphic user interface application, as disclosed herein (e.g., avatar model engine 232, blockchain network engine 234, and application 222). In some embodiments, the avatar model engine may include a guide mesh tool and a ray marching tool, as disclosed herein (e.g., guide mesh tool 242 and ray marching tool 244), and the blockchain network engine may include an encryption tool and a public key validation tool (e.g., encryption tool 246 and public key validation tool 248). Methods consistent with the present disclosure may include at least one or more of the steps in method 700, performed in a different order, simultaneously, quasi-simultaneously, or overlapping in time.

Step 702 includes receiving, from a client device, a request for authenticating the identity of a user of an immersive reality application running in the client device, wherein the user is associated with a subject-based avatar in the immersive reality application. In some embodiments, the server is a third party validating application, and step 702 includes receiving a request, by a second client device running the third party validating application, the request activated on the subject-based avatar by a participant in the immersive reality application. In some embodiments, the immersive reality application is an educational application, and step 702 includes providing a certifiable academic degree to the user. In some embodiments, the immersive reality application is a financial application, and step 702 further includes providing access, to the user, to a personal account in a financial institution. In some embodiments, step 702 includes receiving a request for authenticating a healthcare transaction or a social media transaction including the subject-based avatar.

Step 704 includes verifying, in a server, a public key provided by the client device against a private key stored in the server, the private key associated with the subject-based avatar. In some embodiments, the private key is created from an identity verification token provided by an identity issuing organization, and step 704 includes notifying the identity issuing organization about the request for authenticating the identity of the user. In some embodiments, step 704 includes physically verifying a biomarker or an issued documentation certifying an identity of an owner of the subject-based avatar.

Step 706 includes providing, to the client device, a certificate of validity of the identity of the user when the public key matches the private key.

Step 708 includes storing an encrypted version of the certificate of validity in a memory. In some embodiments, step 708 includes storing the encrypted version of the certificate of validity in a blockchain database. In some embodiments, step 708 includes storing the encrypted version of the certificate of validity in a blockchain database.

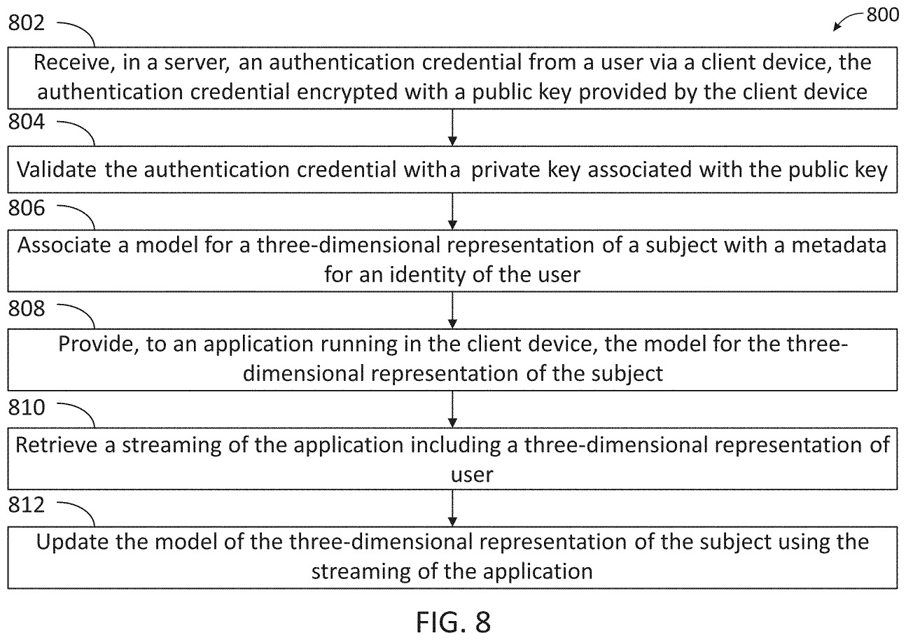

FIG. 8 is a flow chart illustrating steps in a method for authenticating a subject avatar for multiple network applications, according to some embodiments. Method 800 may be performed by a system including client devices, servers, and at least one database communicatively coupled with each other via communications modules via a network, as disclosed herein (e.g., client devices 110, servers 130, databases 152, 252, 352, and 452, communications modules 218, and network 150). The servers and client devices may include processors configured to execute instructions stored in memories as disclosed herein (e.g., processors 212 and memories 220). In some embodiments, the instructions in a memory may include an avatar model engine configured to create and update a personalized avatar model engine, a blockchain network engine, and a graphic user interface application, as disclosed herein (e.g., avatar model engine 232, blockchain network engine 234, and application 222). In some embodiments, the avatar model engine may include a guide mesh tool and a ray marching tool, as disclosed herein (e.g., guide mesh tool 242 and ray marching tool 244), and the blockchain network engine may include an encryption tool and a public key validation tool (e.g., encryption tool 246 and public key validation tool 248). Methods consistent with the present disclosure may include at least one or more of the steps in method 800, performed in a different order, simultaneously, quasi-simultaneously, or overlapping in time.

Step 802 includes receiving, in a server, an authentication credential from a first user via a client device, the authentication credential encrypted with a public key provided by the client device. In some embodiments, step 802 includes requesting an authentication credential from a second user before providing to the second user a second model for a three-dimensional representation of a subject associated with an identity of the second user. In some embodiments, step 802 includes receiving the public key from a second device coupled to the client device, via the client device.

Step 804 includes validating the authentication credential with a private key associated with the public key.

Step 806 includes associating a model for a three-dimensional representation of a subject with a metadata for an identity of the first user.

Step 808 includes providing, to an application running in the client device, the model for the three-dimensional representation of the subject. In some embodiments, the application is a virtual reality application, and step 808 further includes immersing the three-dimensional representation of the first user in a computer-generated reality. In some embodiments, the application is a social network application, and step 808 further includes interacting the three-dimensional representation of the first user with a three-dimensional representation of a second user. In some embodiments, step 808 further includes receiving a video capture of the first user from the client device, feeding the video capture of the first user to the model for the three-dimensional representation of the subject, and providing a video capture of the three-dimensional representation of the first user to the client device. In some embodiments, the application is a personal application for the first user, and step 808 includes receiving the authentication credential including a user identifier, from the application. In some embodiments, step 808 includes allowing the first user and a second user to interact immersed in a virtual reality application via the three-dimensional representation of the first user and a three-dimensional representation of the second user.

Step 810 includes retrieving, from the client device, a streaming of the application including a three-dimensional representation of the first user. In some embodiments, step 810 includes publishing in a blockchain ledger the streaming of the application including the three-dimensional representation of the first user. In some embodiments, step 810 further includes publishing in a blockchain ledger the model of the three-dimensional representation of the subject.

Step 812 includes updating the model of the three-dimensional representation of the subject using the streaming of the application.

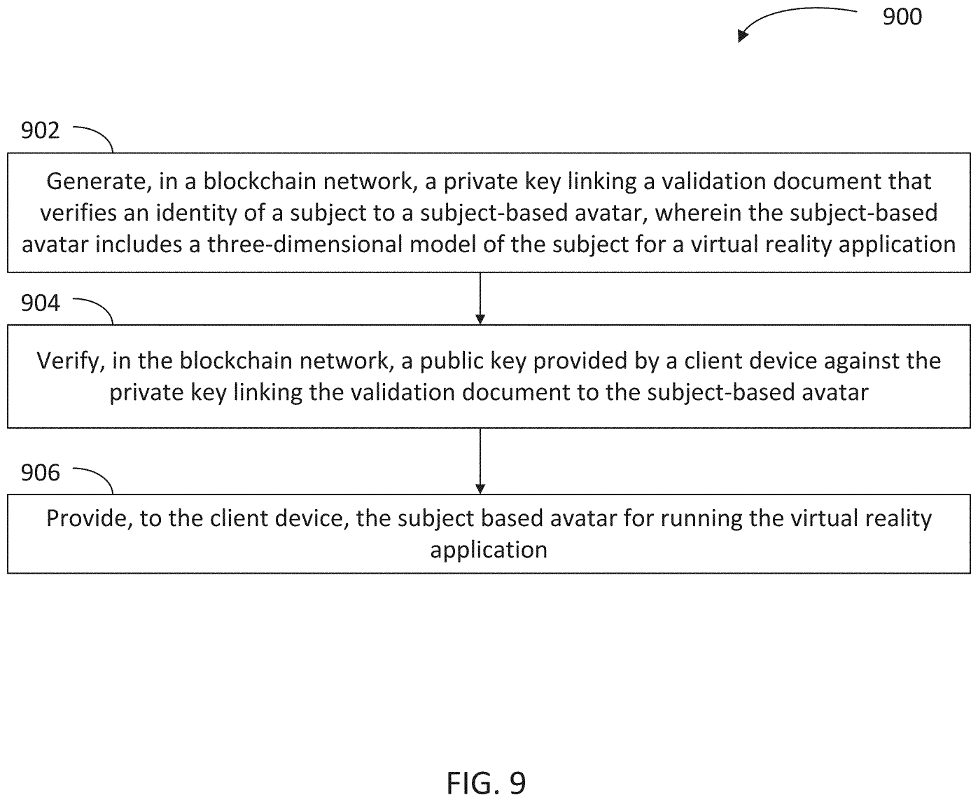

FIG. 9 is a flow chart illustrating steps in a method 900 for authenticating a subject avatar for multiple network applications, according to some embodiments. Method 900 may be performed by a system including client devices, servers, and at least one database communicatively coupled with each other via communications modules via a network, as disclosed herein (e.g., client devices 110, servers 130, databases 152, 252, 352, and 452, communications modules 218, and network 150). The servers and client devices may include processors configured to execute instructions stored in memories as disclosed herein (e.g., processors 212 and memories 220). In some embodiments, the instructions in a memory may include an avatar model engine configured to create and update a personalized avatar model engine, a blockchain network engine, and a graphic user interface application, as disclosed herein (e.g., avatar model engine 232, blockchain network engine 234, and application 222). In some embodiments, the avatar model engine may include a guide mesh tool and a ray marching tool, as disclosed herein (e.g., guide mesh tool 242 and ray marching tool 244), and the blockchain network engine may include an encryption tool and a public key validation tool (e.g., encryption tool 246 and public key validation tool 248). Methods consistent with the present disclosure may include at least one or more of the steps in method 900, performed in a different order, simultaneously, quasi-simultaneously, or overlapping in time.

Step 902 includes generating, in a blockchain network, a private key linking a validation document that verifies an identity of a subject to a subject-based avatar, wherein the subject-based avatar includes a three-dimensional model of the subject for a virtual reality application. In some embodiments, step 902 includes receiving, in the blockchain network, the validation document verifying an identity of a subject. In some embodiments, step 902 includes storing, in a blockchain network, the validation document. In some embodiments, the validation document is a government-issued identity document, and step 902 further includes verifying a source of the validation document via a digital signature in the government-issued identity document. In some embodiments, the validation document is a biometric measurement of the subject, and step 902 further includes verifying that the biometric measurement matches a value stored in a government-based database.

Step 904 included verifying, in the blockchain network, a public key provided by a client device against the private key linking the validation document to the subject-based avatar. In some embodiments, step 904 further includes providing, to the client device, a certificate of validity of the identity of the subject when the public key matches the private key.

Step 906 includes providing, to the client device, the subject-based avatar for running in the virtual reality application.

### Hardware Overview

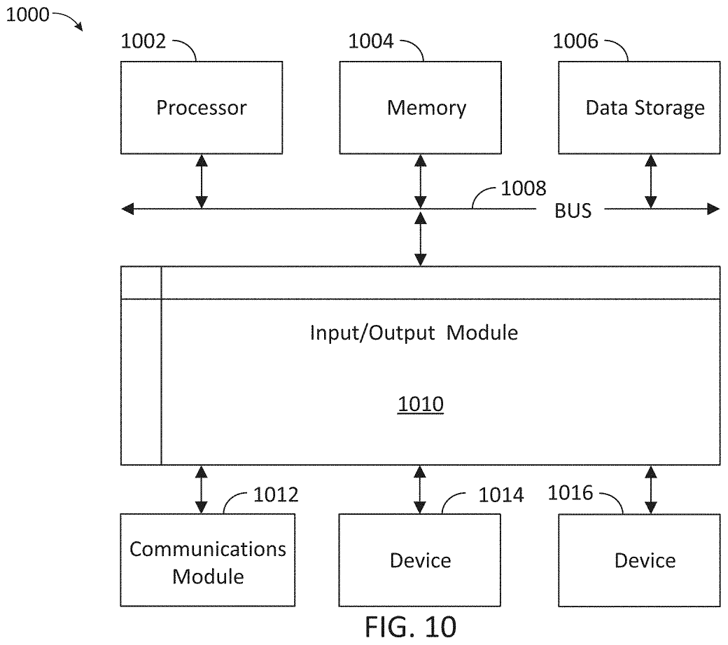

FIG. 10 is a block diagram illustrating an example computer system with which the client and server of FIGS. 1 through 4 and the method of FIGS. 7-9 can be implemented. In certain aspects, the computer system 1000 may be implemented using hardware or a combination of software and hardware, either in a dedicated server, or integrated into another entity, or distributed across multiple entities.

Computer system 1000 (e.g., client 110 and server 130) includes a bus 1008 or other communication mechanism for communicating information, and a processor 1002 (e.g., processors 212) coupled with bus 1008 for processing information. By way of example, the computer system 1000 may be implemented with one or more processors 1002. Processor 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1000 can include, in addition to hardware, code that creates an execution environment for the computer program in question, e.g., code that constitutes processor firmware, a protocol stack, a database management system, an operating system, or a combination of one or more of them stored in an included memory 1004 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, e.g., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1000 further includes a data storage device 1006 such as a magnetic disk or optical disk, coupled to bus 1008 for storing information and instructions. Computer system 1000 may be coupled via input/output module 1010 to various devices. Input/output module 1010 can be any input/output module. Exemplary input/output modules 1010 include data ports such as USB ports. The input/output module 1010 is configured to connect to a communications module 1012. Exemplary communications modules 1012 (e.g., communications modules 218) include networking interface cards, such as Ethernet cards and modems. In certain aspects, input/output module 1010 is configured to connect to a plurality of devices, such as an input device 1014 (e.g., input device 214) and/or an output device 1016 (e.g., output device 216). Exemplary input devices 1014 include a keyboard and a pointing device, e.g., a mouse or a trackball, by which a user can provide input to the computer system 1000. Other kinds of input devices 1014 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1016 include display devices, such as an LCD (liquid crystal display) monitor, for displaying information to the user.

According to one aspect of the present disclosure, the client 110 and server 130 can be implemented using a computer system 1000 in response to processor 1002 executing one or more sequences of one or more instructions contained in memory 1004. Such instructions may be read into memory 1004 from another machine-readable medium, such as data storage device 1006. Execution of the sequences of instructions contained in main memory 1004 causes processor 1002 to perform the process steps described herein. One or more processors in a multi-processing arrangement may also be employed to execute the sequences of instructions contained in memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 1000 can include clients and servers. A client and server are generally remote from each other and typically interact through a communication network. The relationship of client and server arises by virtue of computer programs running on the respective computers and having a client-server relationship to each other. Computer system 1000 can be, for example, and without limitation, a desktop computer, laptop computer, or tablet computer. Computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1002 for execution. Such a medium may take many forms, including, but not limited to, non-volatile media, volatile media, and transmission media. Non-volatile media include, for example, optical or magnetic disks, such as data storage device 1006. Volatile media include dynamic memory, such as memory 1004. Transmission media include coaxial cables, copper wire, and fiber optics, including the wires forming bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
receiving, from a client device, a request for authenticating an identity of a user of an immersive reality application running in the client device, wherein the user is associated with a subject-based avatar in the immersive reality application;
verifying, in a server, a public key provided by the client device against a private key stored in the server, the private key associated with the subject-based avatar;
providing, to the client device, a certificate of validity of the identity of the user when the public key matches the private key; and
storing an encrypted version of the certificate of validity in a memory.

2. The computer-implemented method of claim 1, wherein the server is a third party validating application, and verifying a public key provided by the client device against a private key stored in the server comprises receiving a request, by a second client device running the third party validating application, the request activated on the subject-based avatar by a participant in the immersive reality application.

3. The computer-implemented method of claim 1, wherein receiving a request for authenticating an identity of a user of an immersive reality application running in the client device comprises receiving a request for authenticating a healthcare transaction or a social media transaction including the subject-based avatar.

4. The computer-implemented method of claim 1, wherein the private key is created from an identity verification token provided by an identity issuing organization, further comprising notifying the identity issuing organization about the request for authenticating the identity of the user.

5. The computer-implemented method of claim 1, wherein verifying the public key against a private key comprises physically verifying a biomarker or an issued documentation certifying an identity of an owner of the subject-based avatar.

6. The computer-implemented method of claim 1, wherein the immersive reality application is an educational application, and providing a certificate of validity of the identity of the user comprises providing a certifiable academic degree to the user.

7. The computer-implemented method of claim 1, wherein the immersive reality application is a financial application, further comprising providing access, to the user, to a personal account in a financial institution.

8. The computer-implemented method of claim 1, wherein storing the encrypted version of the certificate of validity in a memory comprises storing the encrypted version of the certificate of validity in a blockchain database.

9. A system, comprising;
a memory storing multiple instructions; and
one or more processors configured to execute the instructions to cause the system to perform operations, comprising:
receiving, from a client device, a request for authenticating an identity of a user of an immersive reality application running in the client device, wherein the user is associated with a subject-based avatar in the immersive reality application;
verifying, in a server, a public key provided by the client device against a private key stored in the server, the private key associated with the subject-based avatar;
providing, to the client device, a certificate of validity of the identity of the user when the public key matches the private key; and
storing an encrypted version of the certificate of validity in a memory.

10. The system of claim 9, wherein the immersive reality application is an educational application or a financial application, and to provide a certificate of validity of the identity of the user the one or more processors execute instructions to provide a certifiable academic degree to the user, or an access, to the user to a personal account in a financial institution.

11. The system of claim 9, wherein to store the encrypted version of the certificate of validity in a memory comprises storing the encrypted version of the certificate of validity in a blockchain database.

12. A computer-implemented method, comprising:
receiving, in a server, an authentication credential from a first user via a client device, the authentication credential encrypted with a public key provided by the client device;
validating the authentication credential with a private key associated with the public key;
associating a model for a three-dimensional representation of a subject with a metadata for an identity of the first user;
providing, to an application running in the client device, the model for the three-dimensional representation of the subject;
retrieving, from the client device, a streaming of the application including a three-dimensional representation of the first user; and
updating the model of the three-dimensional representation of the subject using the streaming of the application.

13. The computer-implemented method of claim 12, wherein receiving an authentication credential comprises receiving the public key from a second device coupled to the client device, via the client device.

14. The computer-implemented method of claim 12, wherein the application is a virtual reality application, further comprising immersing the three-dimensional representation of the first user in a computer generated reality.

15. The computer-implemented method of claim 12, wherein the application is a social network application, further comprising interacting the three-dimensional representation of the first user interacts with a three-dimensional representation of a second user.

16. The computer-implemented method of claim 12, wherein providing the model for the three-dimensional representation of the subject comprises:
receiving a video capture of the first user from the client device;
feeding the video capture of the first user to the model for the three-dimensional representation of the subject; and
providing a video capture of the three-dimensional representation of the first user to the client device.

17. The computer-implemented method of claim 12, wherein the application is a personal application for the first user, further comprising receiving the authentication credential including a user identifier, from the application.

18. The computer-implemented method of claim 12, further comprising publishing in a blockchain ledger the streaming of the application including the three-dimensional representation of the first user.

19. The computer-implemented method of claim 12, further comprising publishing in a blockchain ledger the model of the three-dimensional representation of the subject.

20. The computer-implemented method of claim 12, further comprising allowing the first user and a second user to interact immersed in a virtual reality application via the three-dimensional representation of the first user and a three-dimensional representation of the second user.
